(19) United States
(12) Patent Application Publication
(10) Pub. No.: US 2011/0302928 A1
(43) Pub. Date: Dec. 15, 2011

(54) LIQUID-GAS HEAT EXCHANGER

(75) Inventor: Issam Mudawar, West Lafayette, IN (US)

(73) Assignee: PURDUE RESEARCH FOUNDATION, West Lafayette, IN (US)

(21) Appl. No.: 13/203,435

(22) PCT Filed: Mar. 1, 2010
(86) PCT No.: PCT/US10/25766

§ 371 Date: Aug. 25, 2011

Related U.S. Application Data
(60) Provisional application No. 61/156,133, filed on Feb. 27, 2009.

(51) Int. Cl. F02C 6/08; F28D 15/00

(52) U.S. Cl. 60/782; 165/104.14

(57) ABSTRACT

The heat exchanger includes a large number of small, closely-spaced modules. Within each module of one embodiment, the fuel flows through a series of parallel micro-channels, while the air flows externally over rows of short, straight fins perpendicular to the direction of fuel flow. A theoretical model was developed to predict the thermal performance of the module for various operating conditions. To confirm the accuracy of the model, a module was constructed and tested using water to simulate the aircraft fuel.

### CROSS REFERENCE TO RELATED APPLICATION

This application claims the benefit of priority to U.S. Provisional Patent Application Ser. No. 61/156,133, filed Feb. 27, 2009, entitled HEAT EXCHANGER FOR HIGH MACH NUMBER JET ENGINE, incorporated herein by reference.

### FIELD OF THE INVENTION

Various embodiments of the present invention pertain to liquid-gas heat exchangers, and in particular to fuel-air heat exchangers used in the fuel system of an engine.

### BACKGROUND OF THE INVENTION

As the need for more fuel-efficient modes of transportation becomes an increasing global concern, improved technologies must be developed to meet higher standards of fuel-efficiency without great sacrifices to vehicle performance. This search for greater economy extends to every mode of transportation, from engines in automobiles to gas turbine engines in aircraft. Within the high Mach gas turbine industry, strides have been made to improve aircraft efficiency; however materials and designs are continuously being stretched in search of further improvements.

One approach to improving gas turbine engine efficiency is to cool compressor bleed air before it is used to cool various engine components such as turbine blades. Cooling of the compressor bleed air is typically achieved by using either one of two available heat sinks: the fan bypass air and the fuel. Generally, the fuel is the preferred heat sink because the fuel has higher heat transfer capacity than air, rendering air-fuel heat exchangers more compact and lightweight.

Cooling of the compressor bleed air may not be required for all types of aircraft gas turbine engines. For subsonic engines, the compressor bleed air is cool enough and may therefore be used directly to cool the turbine blades. However, for supersonic engines, the compressor exit temperature is too high to cool the turbine blades; in some cases a heat exchanger may be needed to cool the compressor bleed air. Using the fuel as heat sink, the compressor bleed air is pre-cooled before it is introduced to the turbine blades.

The use of air-fuel heat exchanger in a supersonic engine can result in added pressure drop incurred in both the air and the fuel. Generally, the pressure drop penalty for the fuel is tolerable, but the added pressure drop for the compressor bleed air should be minimized to preclude any appreciable reduction in engine efficiency. Minimizing airside pressure drop is therefore a design concern when attempting to increase the thermal effectiveness of the air-fuel heat exchanger.

Previous efforts to identify optimum air-fuel heat exchanger designs have been focused mainly on investigating and comparing various heat transfer schemes for both the air and the fuel. Most heat exchanger designs involve cross-flow of compressor bleed air across a series of circular tubes carrying the cooler fuel, similar to what is typically encountered in a conventional shell-and-tube heat exchanger. Some designs have used metal foam to enhance heat transfer on the airside. Their tests revealed that the foam is heavy and expensive.

Yet other designs have investigated the merits of enhancing heat transfer on the fuel side using jet impingement. The tube carrying the fuel was modified by inserting a second, smaller co-axial tube. Two different fuels were tested, JP-8+100 and JP-7. The fuel was supplied through the inner tube and injected as a series of jets through small holes in the inner tube. The jets impinged on the inner wall of the outer tube, absorbing the heat from the external air cross-flow. While the jet impingement produced reasonable convective heat transfer coefficients, interactions between the jets and the spent fuel flow in the annulus between the two tubes, as well as the need to utilize a large number of closely spaced jets.

Yet others have investigated heat transfer enhancement on the fuel side by modifying plain fuel tubes with wire coil inserts. The inserts provided improved heat transfer enhancement with JP-10 by creating a tangential swirl mixing effect and increasing heat transfer area.

What is needed are improvements in gas to liquid heat exchangers that offer lightweight, high performance, and low cost. Various embodiments of the present invention do this in novel and unobvious ways.

### SUMMARY OF THE INVENTION

Various embodiments of the present invention pertain to gas to liquid heat exchangers of modular design.

One embodiment of the present invention pertains to a method for exchanging heat between a gas and a liquid. The method includes providing a plurality of heat exchanging modules arranged in a pattern that is radial about an axis. The method includes flowing the gas radially inward through the pattern flowing the liquid within the plurality of modules, and exchanging heat between the liquid and the gas.

Another embodiment of the present invention pertains to an apparatus for exchanging heat between a gas and a liquid. The apparatus includes a gas inlet duct and a gas outlet duct. The apparatus includes a liquid inlet manifold and a liquid outlet manifold. The apparatus includes a plurality of substantially identical heat exchanging modules, each module having a liquid inlet and liquid outlet and a closed-wall interior flowpath therebetween, each interior including a first plurality of spaced-apart projections and a second exterior plurality of spaced-apart projections adapted and configured for exchanging heat between the gas and a wall. The plurality of modules are arranged in a group such the flowpaths of adjacent modules are aligned for parallel flow in a first direction, and configured to flow gas over the exterior of the plurality modules in a second direction not parallel to the first direction.

Another embodiment of the present invention pertains to an apparatus for exchanging heat between a gas and a liquid. The apparatus includes a heat exchanging module having a pair of opposing top and bottom walls and a first plurality of spaced-apart projections within the interior, each of the first projections being structurally coupled to both the top and bottom walls. Each module includes an exterior including a second plurality of spaced-apart external projections adapted and configured for exchanging heat between the gas and the exterior of the top wall, each projection of the second plurality of projections being substantially parallel to each adjacent projection. The liquid flowpath is adapted and configured to flow liquid in a first direction, the second projections are aligned to flow gas in a second direction, and the second direction is substantially orthogonal to the first direction.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1 is a cross sectional schematic representation of a system according to one embodiment of the present invention.

FIG. 2a is a schematic representation of a cross sectional view of the heat exchanger of FIG. 1.

FIG. 2b is a schematic representation of a side cutaway view of the heat exchanger of FIG. 1.

FIG. 3a is a perspective view of a heat exchanging module according to one embodiment of the present invention.

FIG. 3b is a scaled top planar view of the apparatus of FIG. 3a, and including an enlarged view.

FIG. 3c is a cross sectional representation of the apparatus of FIG. 3a.

FIG. 3d is a graphical representation of variation of average convective heat transfer coefficient for laminar flow over a flat plat with plate length. Values are shown for a flow velocity of 30 m/s at one atmosphere and 675° C.

FIG. 3e is a perspective representation of a portion of a heat exchanging module according to one embodiment of the present invention showing the crossflow characteristic of the exchange of heat.

FIG. 3f is a perspective view of inner and outer banks of heat exchanging modules arranged in a radial pattern according to one embodiment of the present invention.

FIG. 3g is a close up of a portion of the apparatus of FIG. 3f.

FIG. 4a is a schematic representation of a system according to another embodiment of the present invention.

FIG. 4b is a perspective representation of a portion of the apparatus of FIG. 4a.

FIG. 5a is a scaled cross sectional representation of a heat exchanging module according to one embodiment of the present invention.

FIG. 5b is a shaded graphical representation of stress contours from a computer model of the apparatus of FIG. 5a.

FIG. 6a is a photographic end view of a module similar to that of FIG. 5a.

FIG. 6b is a photographic view of the other end of the apparatus of FIG. 6a.

FIG. 6c is a side elevational view of the apparatus of FIG. 6a.

FIG. 6d is a top planform view of the apparatus of FIG. 6a.

FIG. 7a is a scaled partial view of a heat exchanging module according to another embodiment of the present invention.

FIG. 7b is a scaled partial view of a heat exchanging module according to another embodiment of the present invention.

FIG. 7c is a scaled partial view of a heat exchanging module according to another embodiment of the present invention.

FIG. 8 is a schematic representation of an analytical model for predicting the thermal performance of a heat exchanging module according to one embodiment of the present invention.

FIG. 9a is a schematic representation showing nomenclature and parameters of the analytical model of FIG. 8.

FIG. 9b is a schematic representation showing nomenclature and parameters of the analytical model of FIG. 8.

FIG. 10 is a schematic representation showing nomenclature and parameters of the analytical model of FIG. 8.

FIG. 11 is a graphical depiction of an equivalent thermal resistance network representing the micro-channel module of the analytical model of FIG. 8.

FIG. 12 is a graphical representation showing outlet air temperature profiles for different water flow rates for the analytical model of FIG. 8.

FIG. 13a is a graphical representation of percent error in predicting airside and water side temperature drop with water flow rate for \dot{m}_{c}=0.00553 kg/s, Th,i=90.5° C., and Tc,i=24.3° C.

FIG. 13b is a graphical representation of percent error in predicting airside and water side temperature drop with water flow rate for \dot{m}=0.0069 kg/s, Th,i=93.6° C.

FIG. 13c is a graphical representation of percent error in predicting airside and water side temperature drop with water flow rate for \dot{m}=0.0097 kg/s, Th,i=69.0° C. and Tc,i=24.0° C.

FIGS. 14a, 14b, and 14c are graphical representations showing a comparison of predicted and measured heat transfer rate for airside, water side and average of two sides with water flow rate for \dot{m}=0.00553 kg/s, Th,i=90.5° C., and Tc,i=24.3° C.

FIGS. 15a, 15b, and 15c are graphical representations showing a comparison of predicted and measured heat transfer rate for airside, water side and average of two sides with water flow for \dot{m}=0.0069 kg/s, Th,i=93.6° C., and Tc,i=24.4° C.

FIGS. 16a, 16b, and 16c are graphical representations showing a comparison of predicted and measured heat transfer rate for airside, water side and average of two sides with water flow rate for \dot{m}=0.0097 kg/s, Th,i=69.0° C., and Tc,i=24.0° C.

FIG. 17 is a graphical representation of percent error in predicting average heat transfer rate versus water flow rate for different operating conditions.

### NOMENCLATURE

a Airside parameter defined in Eq. 5(a)
A_{c,csf} Fuel (or water) fin cross-sectional area
A_{h,csf} Air fin cross-sectional area
A_{h,f} Airside finned area
A_{h,uf} Airside unfinned area
b Fuel-side (or waterside) parameter defined in Eq. 5(b)
cₚ Specific heat at constant pressure
H_{c,ch} Fuel-side (or waterside) micro-channel height
H_{c,w} Module's outer wall thickness
h̅_{c} Average fuel-side (or waterside) heat transfer coefficient
h̅_{h,b} Average airside heat transfer coefficient on back of module
h̅_{h,f} Average airside fin heat transfer coefficient
h̅_{h,uf} Average airside heat transfer coefficient along surface between fins
k_{c} Thermal conductivity of fuel (or water
kₕ Thermal conductivity of air
kₛ Thermal conductivity of heat exchanger module
L Length of module in direction of fuel (or water) flow
mₕ Airside fin parameter
N_{c,ch} Number of fuel-side (or waterside) micro-channels)
N_{h,f} Number of airside fin rows
P_{c,f} Fuel (or water) fin perimeter
P_{h,f} Air fin perimeter
q Heat exchanger module's heat transfer rate
q_{c,exp} Measured water side heat transfer rate
q_{h,exp} Measured airside heat transfer rate
R_{A} Thermal resistance of branch A of module's equivalent resistance
R_{B} Thermal resistance of branch B of module's equivalent resistance
R_{c,2} Surface 2 base convective resistance
R_{c,3} Surface 3 base convective resistance
R_{cond} Module's outer wall conduction resistance
R_{c,swl} First fuel (or water) sidewall resistance
R_{c,sw2} Second fuel (or water) sidewall resistance
R_{h,l} Airside resistance
R_{h,4} Airside base resistance
Rₜₒₜ total (equivalent) resistance
T_{c} Fuel (or water) temperature
T_{c,in,exp} Measured waterside inlet temperature
T̅_{c,o} Mean outlet fuel (or water) temperature
T_{c,o,exp} Measured waterside mean outlet temperature
T_{c,o,th} Theoretical waterside outlet temperature
Tₕ Air temperature
T_{h,in,exp} Measured airside inlet temperature
T̅_{h,o} Mean outlet air temperature
T_{h,o,exp} Measured airside mean outlet temperature
T_{h,o,th} Theoretical airside mean outlet temperature
U Overall heat transfer coefficient
W Width of module in direction of air flow
W_{c,ch} Fuel-side (or waterside) micro-channel width
W_{c,w} Fuel-side (or waterside) micro-channel wall thickness
W_{h,ch} Airside channel width
ηh,f Airside fin efficiency

### Greek Symbol

φ Ratio of mean to initial temperature difference

### Subscripts

c Cold fuel stream (or simulated water stream)
h Hot air stream
s Solid surface

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, with discussion pertaining to a specific composition of matter, that description is by example only, and does not limit the applicability of other species of that composition, nor does it limit the applicability of other compositions unrelated to the cited composition. Some drawings may be described as being “scaled.” Such drawings represent a single embodiment of the present invention, and shall not be construed as limiting on other embodiments. However, it appreciated that such drawings may indicate scaling factors that are inventive.

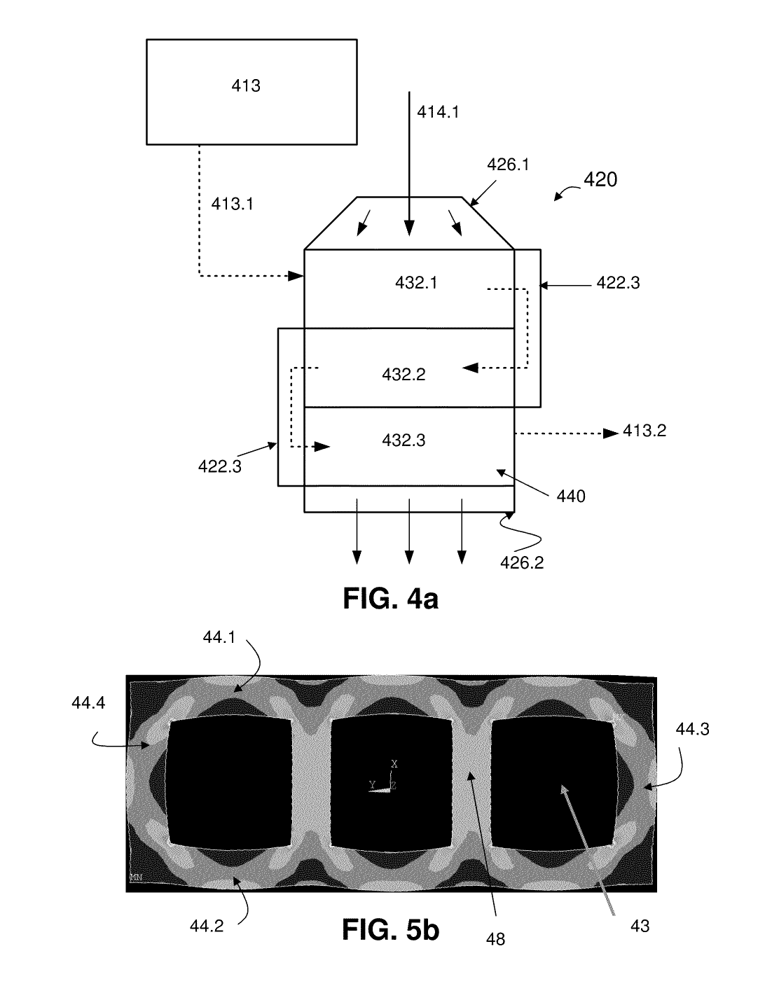

One embodiment of the present invention pertains to heat exchangers that are compact, lightweight and effective. In one embodiment the heat exchanger is comprised of many modules that can be arranged to suit a variety of engine envelopes. FIG. 4a illustrates the basic construction of a single module. The fuel is routed through a series of parallel micro- or mini-channels formed in a thin monolithic metallic structure. Aside from their highly compact and lightweight design, these devices increase both heat transfer area to volume ratio and convective heat transfer coefficient on the fuel side. One embodiment of the new module design also enhances heat transfer on the airside with the use of short straight fins as illustrated in FIG. 4a. The fins are formed in rows and aligned with the airflow but perpendicular to the direction of the fuel flow. These fins enhance airside heat transfer in two ways. First, they increase heat transfer area compared to a bare surface. Second, by using many short fins as opposed to continuous fins, their heat transfer coefficients are based on repeated reinitiating of the airside boundary layer.

Another aspect of some embodiments of new module is that it allows the air-fuel heat exchanger to be configured in variety of design envelopes, such as annular or rectangular, depending on volume, weight or other constraints set by the engine manufacturer. FIG. 4b shows an annular design, in which the air is introduced radially inwards across two of radial stages of closely spaced cross-flow micro-channel modules. Not shown in this figure are the shared inlet and outlet headers for the modules.

An analytical/numerical model was constructed to characterize the thermal performance of the heat exchanger module. The model validation was assessed by substituting the fuel with water. The experimental facility developed for the study, the heat exchanger module construction and instrumentation, and experimental methods used are described. Experimental results and comparisons with the analytical/numerical predictions are presented.

One embodiment of the present invention concerns the design of a new modular high performance air-fuel heat exchanger for supersonic turbine engines. Aside from maximizing heat transfer between the air and the fuel, the proposed design is modular, minimizes weight and volume, and reduces airside pressure drop compared to conventional cross-flow designs.

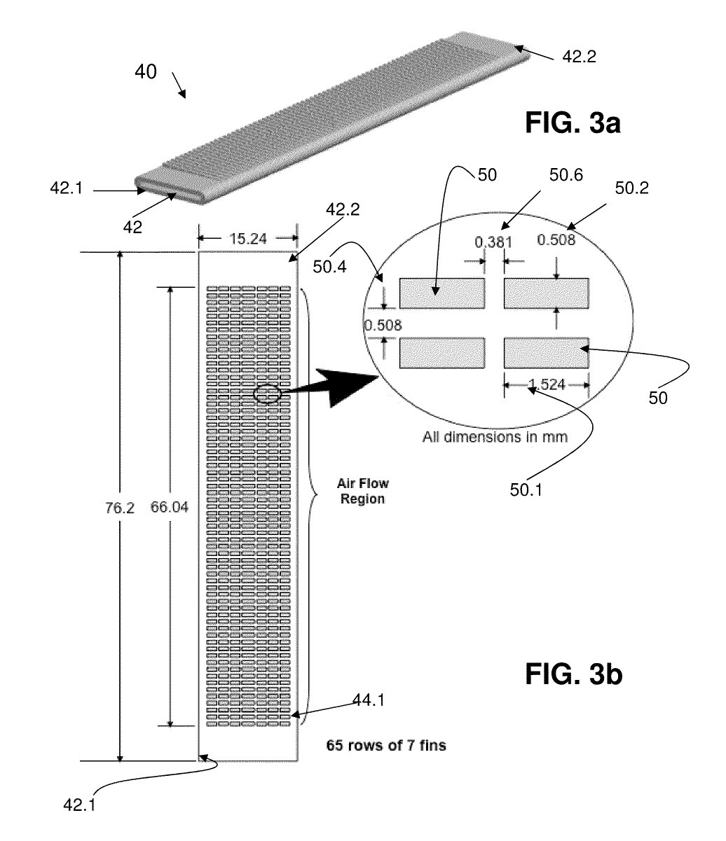

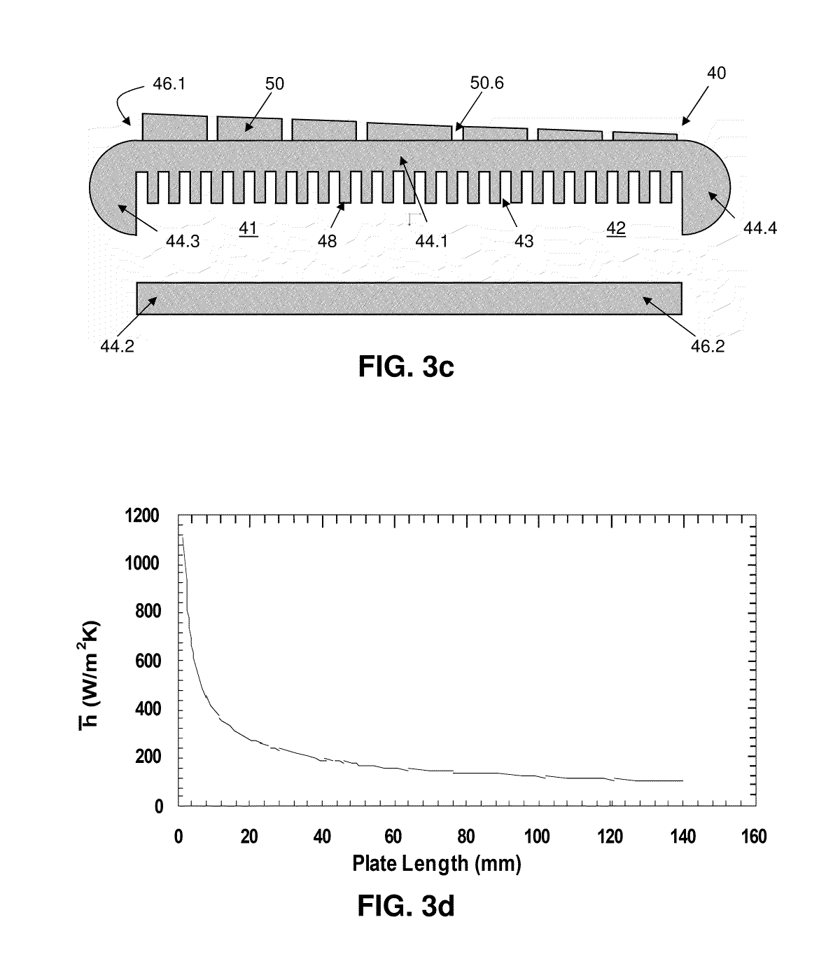

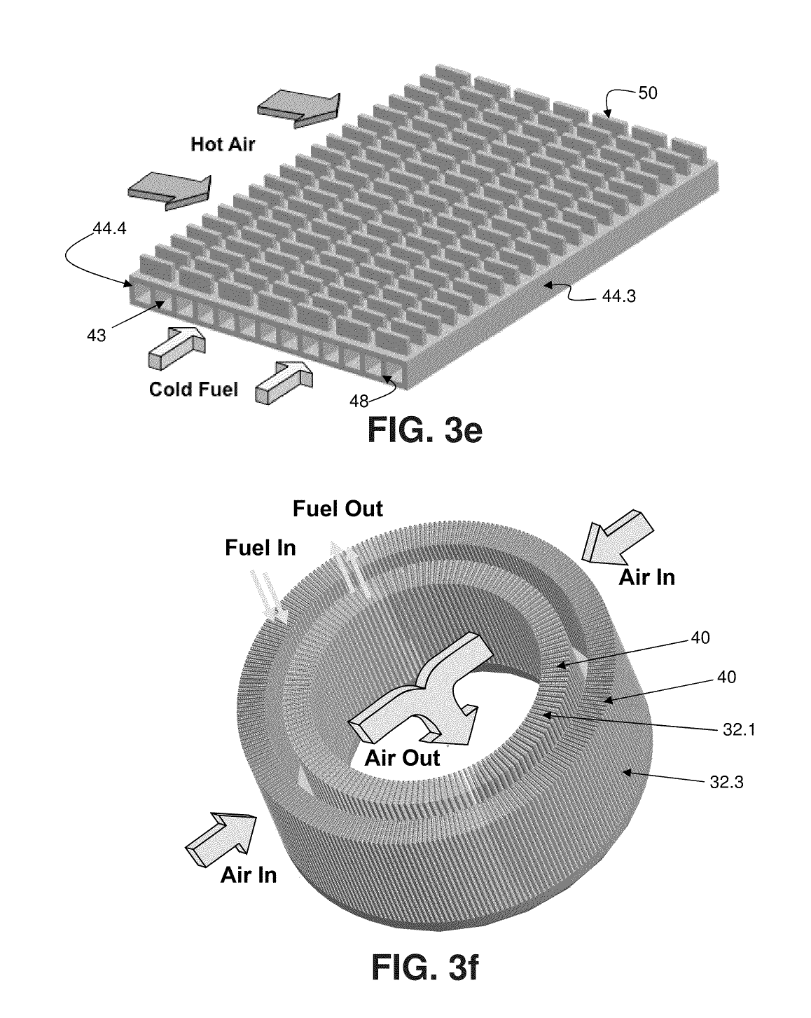

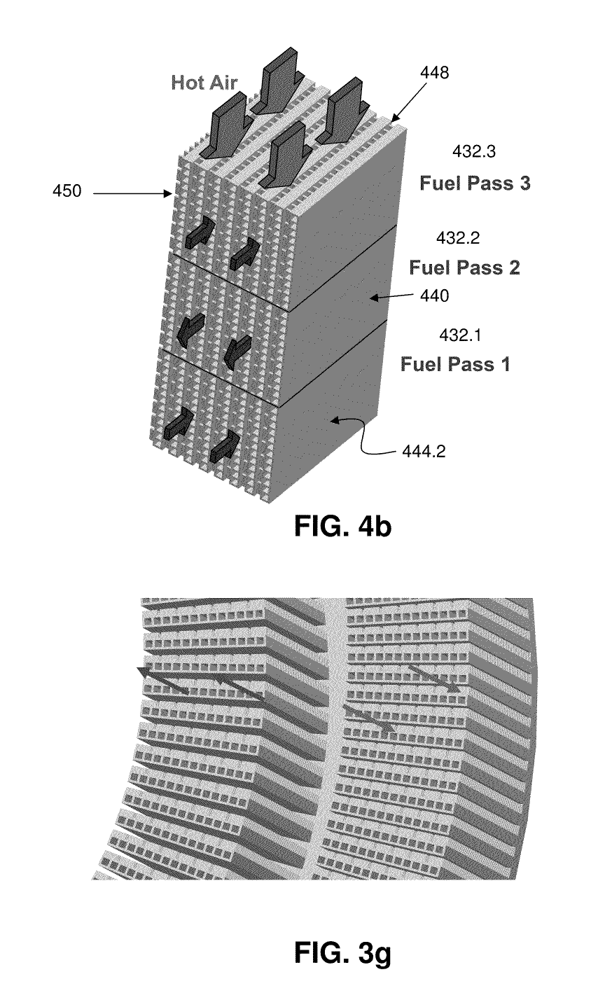

The proposed heat exchanger is comprised of several modules that are arranged to suit various engine envelopes. FIG. 3 show the basic construction of a single module. The fuel is routed through a series of parallel mini- or micro-channels formed in a monolithic metallic plate. Aside from their highly compact and lightweight design, these flow devices increase both heat transfer area and convective heat transfer coefficient on the fuel side.

The heat transfer enhancement can be understood for the case of laminar fully developed fuel flow. Since the Nusselt number for this type of flow is a constant, the heat transfer coefficient is inversely proportional to the hydraulic diameter. This implies the heat transfer performance may be enhanced simply by choosing a smaller hydraulic diameter, provided the increased pressure drop is manageable. However, reducing the diameter increases the of fuel passage blockage due to “coking”. Coking is a thermal decomposition of jet fuel, which produces insoluble materials—deposits—at elevated temperatures.

The proposed module design also enhances heat transfer on the airside with the use of short straight fins as illustrated in FIG. 3. The fins are formed in rows and aligned with the airflow but perpendicular to the direction of the fuel flow. These fins enhance airside heat transfer in two ways. First, they greatly increase heat transfer area compared to a bare surface. Second, because they are short, they tend to re-initiate airside boundary layer development to capitalize upon the large heat transfer coefficient attainable with thin boundary layer flows. This behavior is depicted in FIG. 3d for laminar airflow at 30 m/s (representative of air speeds of practical interest in the supersonic engines), 1.013 bars and 675° C. over a flat plate.

The average heat transfer coefficient is very high for very short fins, but drops off sharply with increasing fin length. This proves the airside heat transfer performance of the heat exchanger module would greatly benefit from using many short fins as opposed to fewer longer fins or a single continuous fin. However, it is appreciated that the fin geometries shown herein can also be considered as a single fin that has a plurality of interruptions along its length. Further, these interruptions can be generalized, in some embodiments, to localized changes in geometry that result in abrupt changes in flow pattern, and reinitiate the thermal boundary layer and aerodynamic boundary layer. Another aspect of the proposed fin geometry is that it provides more streamlined airflow as opposed to the cross-flow prevalent in conventional air-fuel heat exchangers. This feature helps decrease airside pressure drop.

Another aspect of the proposed module is that it allows the air-fuel heat exchanger to be configured in variety of design envelopes, such as box-type design or annular design, depending on volume, weight and other constraints set by the engine manufacturer. It is appreciated that annular designs can be a complete circle, or a segment of a circle, and further that the overall shape can be curved such as in an oblong shape.

In the box-type heat exchanger, shown in FIGS. 4a and 4b, several modules are mounted side by side to form a fuel pass segment, and several fuel pass segments are stacked together to form a full heat exchanger. The configuration depicted in FIG. 4b includes three fuel passes, where fuel direction is reversed between consecutive passes, while the air continues to flow in the same direction.

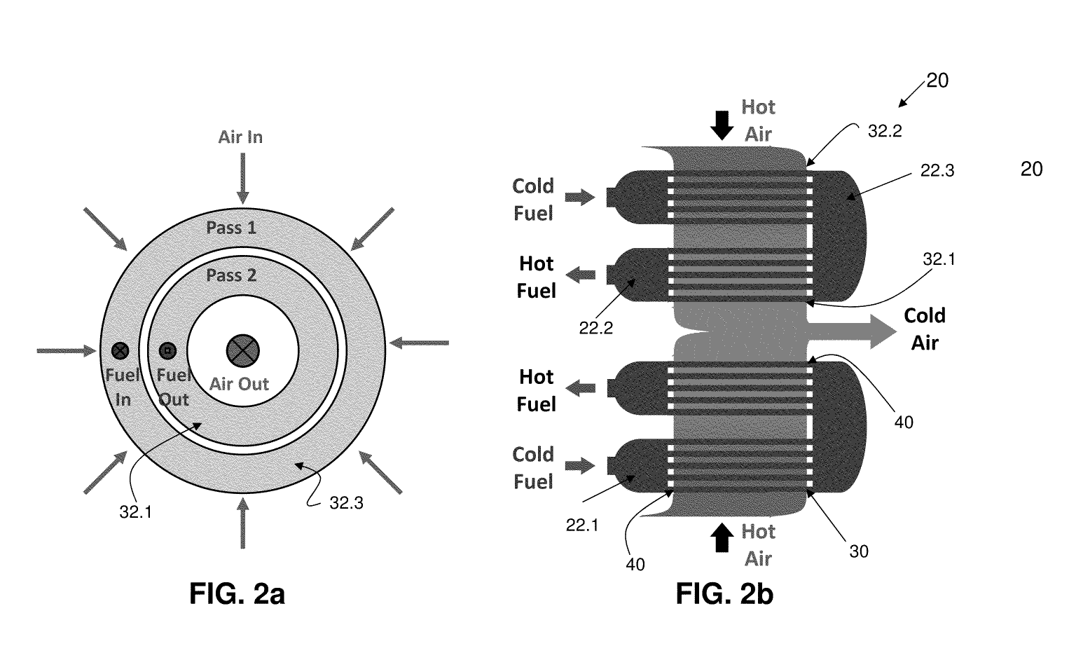

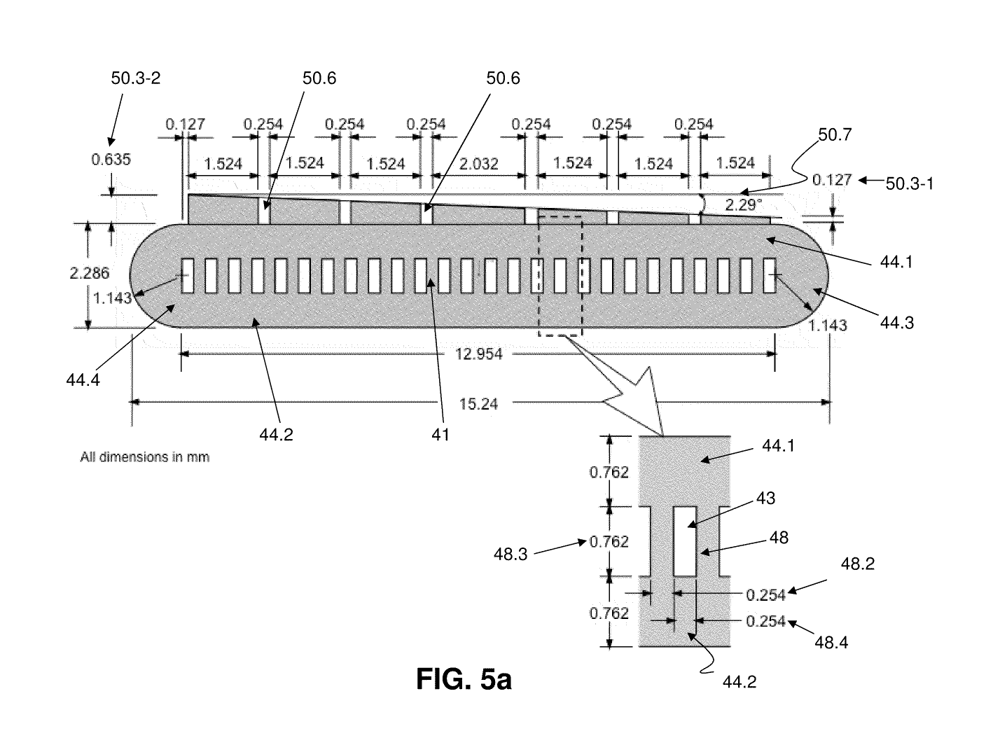

Yet another embodiment pertains to an annular design comprised of multiple radial modules. As shown in FIG. 2a, the hot air enters the heat exchanger radially inwards and exits axially through the center. As depicted in FIG. 5a, the height of the airside fins decreases radially inwards to allow for closer packing of modules in each radial pass. The configuration depicted in FIG. 2b includes two radial fuel passes, where the fuel enters the annular heat exchanger through the outer pass and exits through the inner, and one air pass.

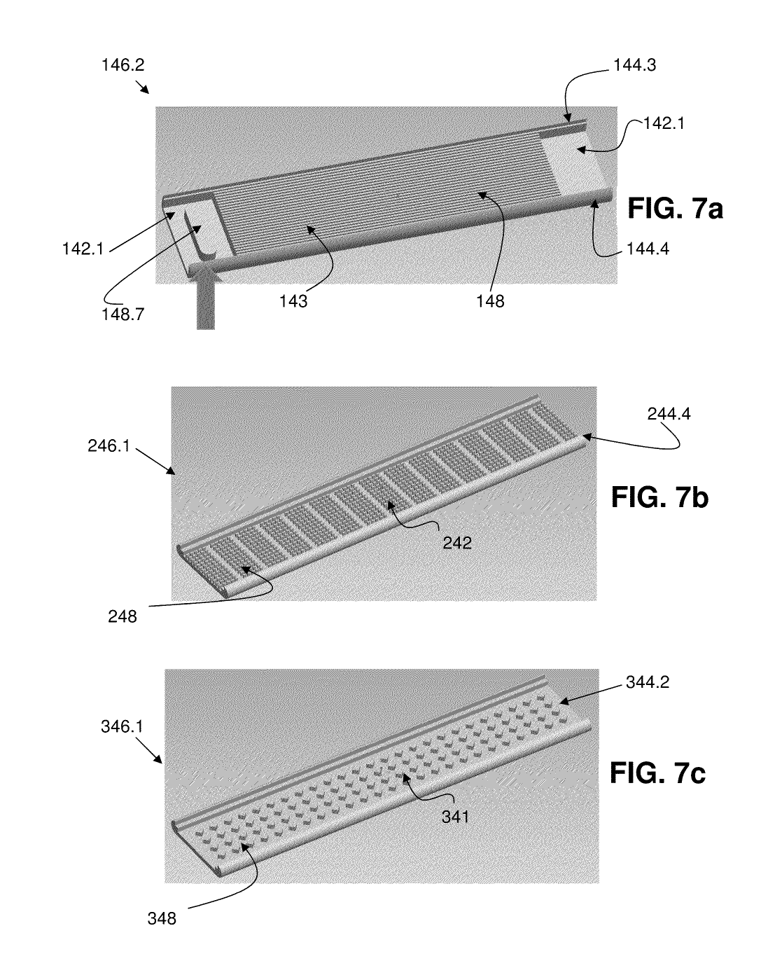

FIG. 7 show several possible modifications to enhance the fuel-side heat transfer performance of the individual heat exchanger modules. The module is shown without the top layer to capture the inner (fuel-side) features of the module only. A protrusion (post) near the fuel inlet helps stagnate the fuel flow, creating a plenum effect within the module that helps redistribute the flow uniformly among the micro-channels. Other variations include cutting the walls of the fuel micro-channels into shorter fins or replacing them with diamond-shaped fins. The rows shorter fins and diamond-shaped fins can be either aligned with the fuel flow as shown in FIG. 7 or offset relative to one another.

Some embodiments of the present invention satisfy one or more constraints that are dictated by both engine performance and its operating environment. The heat exchanger should be able to lower the compressor bleed air temperature to a level that is dictated by cooling requirements of the turbine and afterburner, as well as engine efficiency requirements. As discussed earlier, the various embodiments proposed herein greatly improve air temperature drop compared to existing heat exchanger designs.

Second, the weight of the heat exchanger should be minimized so that the improvement in engine efficiency achieved by cooling the compressor bleed air is not too compromised by the increased engine weight. The added weight penalty is one reason for using an air-fuel heat exchanger over an air-air heat exchanger. Closely associated with heat exchanger weight is compactness. Because space inside the engine and engine nacelle is limited, the heat exchanger should transfer the required amount of heat from the air to the fuel in the smallest volume possible. The proposed design is effective at reducing both the weight and volume of the heat exchanger for high Mach turbine engines, as well as for any gas turbine engine.

Another heat exchanger design consideration is airside pressure drop. Compressor bleed air pressure losses are incurred in various engine components that require cooling. The air-fuel heat exchanger introduces an additional pressure drop penalty, which can compromise engine efficiency. It is therefore desired that the task of increasing heat airside transfer area be achieved with minimal airside pressure drop. As indicated earlier, fuel side pressure drop is less taxing to engine efficiency. The streamlined airside fins and absence of flow blockage found in cross-flow heat exchanger designs render the proposed design effective at reducing airside pressure drop.

However, the high pressures within the fuel system place a pressure differential across the walls of the module. Modules according to some embodiments of the present invention utilize the internal projections within the interior liquid flow path of the module to provide a structural connection between opposing walls of the module. By using the internal heat transferring features as structural features, the thickness of the module walls can be reduced and the overall weight of the heat exchanger likewise reduced.

A fourth factor is heat exchanger material. Since high Mach engines operate at elevated temperatures, the heat exchanger should be fabricated from high temperature nickel-based alloys. Choice of material also has a bearing on thermal performance, which depends on the material's thermal conductivity. Material choice may be based on structural integrity requirements. The ability of the heat exchanger modules to withstand the air and fuel pressures depends on the yield strength of the material used. Structural design also influences heat exchanger weight. The proposed design lends itself well to the use of many different alloys, including nickel-based alloys.

The fifth constraint in heat exchanger design is associated with the maximum temperature the fuel is allowed to reach. As previously mentioned, aircraft fuel is susceptible to a thermal decomposition phenomenon called “coking” when subjected to elevated temperatures. The insolubles or “coke” that is formed can clog fuel passages and cause hotspots on the fuel passage surfaces. Preventing coking from occurring in the heat exchanger requires that the hottest fuel passage location be kept below the fuel coking temperature. Because of the high heat transfer coefficient attainable on the fuel side, the proposed design is effective at reducing fuel passage temperatures and, therefore, combating coking.

The various embodiments of heat exchangers described in this patent include one or more of the following design aspects: (1) modularity of design; (2) adaptability to box-type design; (3) adaptability to radial design for compatibility with turbine engine shape and envelope; (4) increased heat transfer performance on airside with the use of short fins; (5) increased heat transfer performance on the fuel side by using small fuel passages; (6) reduced possibility of coking because of the reduced fuel passage wall temperatures; (7) reduced airside pressure drop by using streamlined air fin passages and minimal flow blockage; (8) ability to dissipate sufficient rates of heat between the turbine engine's air and the fuel in minimal weight and volume; and (9) adaptability to applications other than turbine engines that require high rates of heat transfer between a gas and a liquid with minimum weight and volume, and minimal gas side pressure drop.

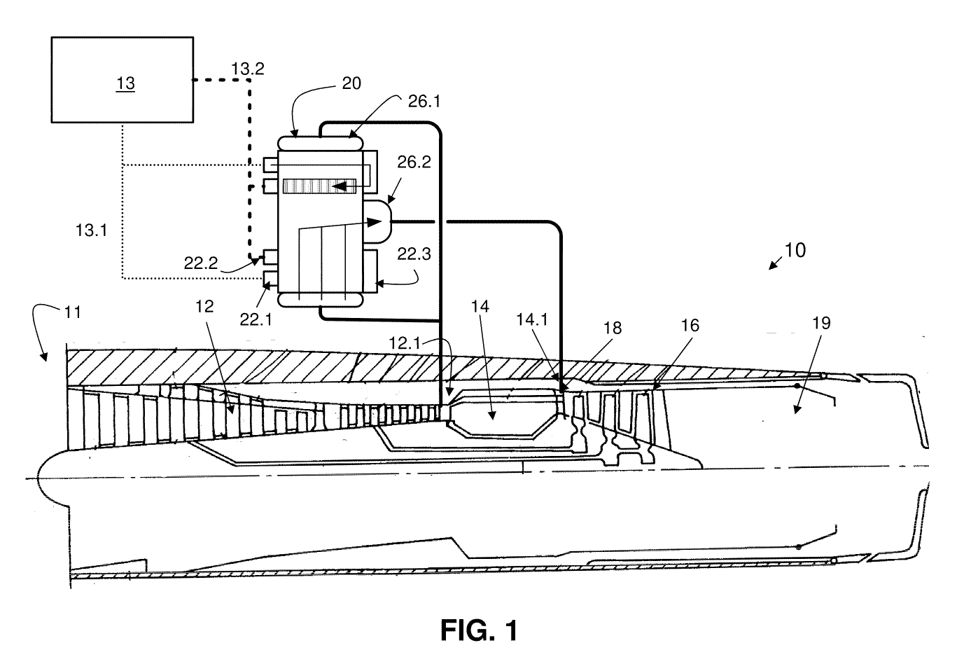

FIG. 1 is a cut-away schematic representation of a turbojet 10 such as a Rolls-Royce Olympus engine. Engine 10 includes an inlet 11 providing air to an axial compressor 12. Compressed air from compressor 12 is provided to a combustor 14 where it is mixed with fuel, burned, and provided to a turbine section. Exhaust gas exiting turbine 16 is expanded across a nozzle 19 to produce thrust.

Engine 10 includes an air inlet port 14.1, such as a port for providing cooling air to the first stage vanes at the exit of the combustor. Typically, compressed air from outlet port 12.1 of compressor 12 is provided to cool the first stage vanes, or other hot section components. In one embodiment of the present invention, compressed air is provided from outlet port 12.1 through various pipes to the inlet air ducts 26.1 of the heat exchanger 20.

In one embodiment, heat exchanger 20 receives the compressed gas in a circular duct 26.1 and flows the gas in a radially inward flow pattern as indicated by the three-legged arrow of FIG. 1.

Air exiting assembly 20 flows into a central outlet duct 26.2 at a lower temperature than the air entering duct 26.1. The compressed gas has exchanged heat with fuel used to power engine 10. The cooled, compressed gas is provided by piping to inlet port 14.1 of engine 10, where it is used to cool various hot section components.

Although what has been shown and described is a heat exchanger 20 that is external to a turbojet engine, it is understood that the invention is not so limited. Heat exchangers described herein are applicable to any type of gas turbine engine, and further are applicable in any situation where it is desirable to exchange heat between a gas and a liquid. Further, although the system in FIG. 1 is discussed with regard to removing heat from compressor air and providing that heat to fuel, it is understood that other embodiments of the present invention are applicable to the heating of the gas and cooling of the liquid.

FIG. 1 shows a heat exchanger 20 that is external to engine 10. The present invention is not so constrained, and includes heat exchangers that are packaged within an engine, or more generally, packaged within a larger system. As one example, a heat exchanger according to various embodiments of the present invention can be incorporated as a component within engine 10, such as a heat exchanger coupled to the diffuser of the engine. In this embodiment, air exiting the compressor is readily available internally to flow over the individual modules. Further, fuel exiting the modules (after cooling the compressor discharge air) can be provided more directly to the fuel nozzles that introduce fuel to the combustor. With regard to coking of these modules, it is appreciated that the heat exchanger assemblies can be purged of fuel during or after shutdown. Further, in some embodiments, the turbojet engine is expendable, and the condition of the engine after its successful flight is not a concern.

FIG. 1 shows a fuel system 13 that provides fuel under pressure in a supply line 13.1 to a fuel inlet manifold 22.1 of heat exchanger 20. This fuel flows through a plurality of heat exchanging modules 40 in which heat is exchanged with gas from inlet duct 26.1. The fuel flows in an essentially straight path in a direction substantially orthogonal to the radially inward path of airflow. The fuel flow exits from one end of a bank 32 of modules 40, whereupon it enters a return manifold 22.3 and subsequently flows within another group or bank 32 of modules 40. Flow exiting these modules is received within a return manifold 22.2, whereupon it is provided in return plumbing 13.2 to fuel system 13. Preferably, modules 40 within a bank 32 are arranged such that the module inlets are in fluid communication with a common inlet manifold, and further that the module fuel outlets are in fluid communication with a collecting manifold, such that the individual fuel flow paths 42 are in parallel with one another.

FIGS. 2(a) and 2(b) are schematic representations of heat exchanger 20. FIG. 2(a) is an axial schematic, and shows the radially-inward flow of air, first through an outer bank 32.3, and then through an inner bank 32.1. Air exiting from inner bank 32.1 flows toward the central line of module 20, whereupon the direction of flow is changed to a substantially axial direction. In some embodiments, heat exchanger 20 includes an inner air collection duct that includes one or more turning vanes that provide the substantially orthogonal change in air flow direction with minimal pressure loss.

FIG. 2(b) is a schematic side view of heat exchanger 20. It can be seen that cold fuel received within inlet manifold 22.1 flows in a direction substantially orthogonal to the direction of airflow, is then reversed 180° in a collector 22.3, and subsequently flows within inner bank 32.1 of modules 40.

FIGS. 3(a), 3(b), and 3(c) show various views of a single heat exchanging module 40 according to one embodiment of the present invention. Each module 40 includes an interior 41 defined by top and bottom walls 44.1 and 44.2, respectively, and opposing sidewalls 44.3 and 44.4. Note that FIG. 3(c) is shown exploded with bottom wall 44.2 moved downward to illustrate one example of construction.

Interior 41 provides a fuel flow path 42 along the length of module 40. Fuel enters an inlet 42.1 that is in fluid communication with inlet manifold 22.1. Flow exits module 40 from a fuel outlet 42.2 and is thereupon received within an outlet manifold 22.2 or a return manifold 22.3. In one embodiment, heat exchanging module 40 has an interior 41 shaped similar to the interior of a flattened tube.

In some embodiments, interior 41 includes a plurality of internal projections 48 that exchange heat between the liquid flowing within flow path 42 and the walls of module 40. Referring to FIG. 3(c) in one embodiment projections 48 form a plurality of flow channels 43 each defined by a pair of adjacent projections 48 and the top and bottom walls of module 40. Preferably, these channels 43 have a hydraulic diameter that is less than about one millimeter. It is appreciated that even with flow channels 43 of a small hydraulic diameter, heat exchangers constructed according to some embodiments of the present invention induce relatively little pressure drop in the flowing liquid. Such a flow characteristic is achieved by arranging a plurality of the modules for parallel flow as a bank 32. However, it is appreciated that in some embodiments the pressure drop is not a consideration, and heat exchangers with only a single module 40 are contemplated in some embodiments of the present invention.

In the embodiments shown in FIG. 3(c), projections 48 are integral with a top wall 44.1. Top wall 44.1 further includes an exterior surface that includes a plurality of external fins 50 that are adapted and configured for exchanging heat between the flowing gas and the walls of module 40. As best seen in FIG. 3(b), an exterior surface of module 40 includes a plurality of rows of fins 50. In one embodiment, each fin has a width 50.2 and a lateral spacing 50.4 from the adjacent fin through which gas flows. As noted in FIG. 3(b), in one embodiment exchanger 40 includes 65 rows of fins 50.

As best seen in the inset of FIG. 3(b) and FIG. 3(c), in some embodiments fins 50 include a disturbance feature 50.6 that functions to restart the boundary layer of the gas flowing over fin 50. Disturbance 50.6 is adapted and configured to reinitiate the boundary layer by means of a sufficiently abrupt change in local geometry. In one embodiment, the disturbance is a gap 50.6, although in other embodiments the disturbance can also be a necked-down cross section of less width than the width 50.2 of the fin. In yet other embodiments the disturbance feature 50.6 is a localized increase in width, that is wider than width 50.2. In yet other embodiments, the disturbance feature 50.6 is incorporated into the top surface of top wall 44.1, such as a trip wire. Various embodiments of the present invention contemplate means for reinitiating the boundary layer of any of these aforementioned geometry changes, and further including methods of boundary layer reinitiation known to those of ordinary skill in the art.

As shown in FIGS. 3(b) and 3(c), in one embodiment a fin 50 includes 6, equally spaced aerodynamic disturbances 50.6. Although what has been shown and described is a single fin with a plurality of geometric, aerodynamic disturbances, those of ordinary skill in the art will recognize that the fin structures of FIGS. 3(b) and 3(c) could also be described as a plurality of short-length fins in a linear arrangement. With such a view, the end of each “short” fin creates a wake disturbance that presents turbulence to the leading edge of the short fin immediately downstream.

As will be appreciated from FIGS. 3b, c, and 4a, fins 50 are adapted and configured to provide good heat transfer with minimum aerodynamic drag in the direction of air flow. Further, this direction of air flow is not in the same direction as the flow of liquid within interior 41. Preferably, the gas and liquid flows are substantially orthogonal to one another, although those of ordinary skill in the art will recognize that included angles substantially less than ninety degrees can still accomplish significant heat transfer between the gas and liquid.

FIGS. 3c and 5a show cross sectional views of a module 40 according to one embodiment of the present invention. In FIG. 5a, bottom plate 46.2 has been joined structurally into top plate 46.1. Both of these figures also show fins 50 that have been adapted and configured for close spacing within a radially-arranged bank of heat exchanging modules. Fins 50 have a height 50.3 that varies across the width of module 40. At one side of module 40, the outermost edge of the first fin 50 has a height 50.3-2 that is greater than the height 50.3-1 of the external-most edge of the fin 50 on the other side of the module. In one embodiment, the top surfaces of the fins 50 are aligned at an angle that is about 2.3 degrees relative to the top surface of the module. This monotonically decreasing height (and also with a constant angle 50.7) provides for optimum spacing of the modules in a radial bank. In such a bank, the top surfaces of fins 50 are generally parallel to the bottomside of an adjacent module 40. In such a packing arrangement, the angular gap between the top of one module and the bottom of an adjacent module is substantially filled with projections 50 as shown in FIG. 5a, these projections having a variable height across their width that closely matches the angular spacing of the modules 40. However, it is recognized that in rectangularly arranged banks, fins 50 have heights that are substantially constant across their width, as best seen in FIG. 3e.

In some embodiments, variable height fins of the same variable characteristic are used in multiple banks of a radially-arranged heat exchanger. In one of the banks (such as the outermost bank) the height variation across the width of the heat exchanger is chosen to provide closest packing between adjacent modules. Using the same module in a radial bank with a smaller radius will result in the variable height being somewhat mismatched in this second bank, since each module of the second bank would be contained within a larger angular segment (i.e., the inner bank is arranged at a smaller radius, and therefore a smaller number of modules occupies the 360 degrees of the extent of the inner bank). It is appreciated that the variable fin height 50.7 of a module can have shapes other than the linear shape shown in FIG. 5a. As one example, each of the fin rows (viewing a single fin 50 as a plurality of shorter fins interrupted by spaces 50.6) can be of a constant height individually, but with the height of each fin being less than or equal to the height of the preceding short fin (such as from left to right in FIG. 5a). Some embodiments of the present invention contemplate that the height of the fins extending across the width of the heat exchanging module change monotonically as viewed going across the module in a single direction toward the center of a radially-arranged bank.

FIG. 3c also shows one approach for construction of a module 40. Module 40 includes in one embodiment a top plate 46.1 used for fabrication of the top wall 44.1, sidewalls 44.3 and 44.4, as well as internal projections 48 and fins 50. The fins 48 and 50 can be machined into the plate. A substantially planar bottom plate 46.2 can then be attached to the machined top plate 46.1. Preferably, bottom plate 46.2 is coupled to top plate 46.1 such that the free end of each projection 48 is structurally connected to the inner surface of bottom plate 46.2, such as by brazing, welding, or diffusion bonding. By structurally connecting each internal projection 48 to both the top and bottom walls, module 40 can be a pressure vessel capable of internally flowing fuel in a gas turbine fuel system, in which fuel pressure can be in excess of 1,000 psi.

FIG. 5(b) shows graphical output from a stress analysis program. It can be seen that liquid flowing under pressure within channels 43 distort the shape of the channel. The top and bottom walls 44.1 and 44.2, respectively, bulge slightly outward in between projections 48. Each projection 48 is structurally connected to both the top wall 44.1 and the bottom wall 44.2. The maximum stresses are predicted to occur in the outermost corners of the channels 43 approximate to sidewalls 44.4 and 44.3.

Further, it is appreciated that although top plate 46.1 has been described as a machining of a flat plate, the present invention is not so constrained, and further includes other fabrication methods, including chem milling and electrochemical milling, and casting (either conventionally, or as a single crystal oriented to provide maximum strength to the pressure vessel) and sintering of powdered metal, as examples. Further, it is appreciated that projections 48 can be machined onto bottom plate 46.2, and then structurally attached to the inner surface of top wall 44.1. Further, in some embodiments, the projections 48 are integral with the bottom plate, and the external fins 50 are integral with the top plate. It is appreciated that sidewalls 44.3 and 44.4 can be integral with either the top wall or the bottom wall, or can be fabricated and attached separately.

FIGS. 4(a) and 4(b) are partial and full schematic representations, respectively, of a heat exchanger 420 according to another embodiment of the present invention. Heat exchanger 420 includes three banks of heat exchanging modules 440 arranged in a generally rectangular pattern. A cooling liquid is received under pressure from a liquid supply 413 through appropriate plumbing 413.1 into a liquid manifold inlet 422.1. Fuel flows along the length of a module 440 in a first bank 432.3, and then is collected and provided to the inlet of a second bank 432.2 of modules 440. Fuel exiting this intermediate bank is subsequently received within a second collector 422.3, and is thereupon directed into the inlet of a third bank of heat exchanger 432.1. Liquid exiting the third bank of heat exchangers can then be used for motive power, combustion, returned to a drain, or used in any manner.

It is appreciated that various embodiments of the present invention can be used to construct a heat exchanging bank of modules in any configuration. Although what has been shown and described are modules that have substantially rectangular planforms (such as those incorporated in both the radial and rectangular banks described above) yet other embodiments include modules having a curving plan form, such as modules that further include external fins 50 that form parallel, curving passageways for directing the external airflow. It is appreciated that a heat exchanger according to some embodiments of the present invention are economical to manufacturer, even with complex shapes, when all of the modules in a bank are identical in construction.

A flow of hot gas is provided into an inlet gas duct 426.1 that is in fluid communication with bank 432.3 of heat exchangers 440. The exterior of this first bank is in fluid communication with the exterior of the second bank 432.2, and the gas subsequently passes over the fins 450 of second bank 432.2. This cooled gas is subsequently received by the third bank of heat exchangers 432.1, after which the cooled gas is exhausted. This cooled gas can be used to cool another structure, for heating or cooling of an environment, dumped to a thermal reservoir, or used in any manner. It is appreciated that the heat exchangers disclosed herein can be used for cooling the liquid, heating the liquid, cooling the gas, or heating the gas, as appropriate to different situations.

FIGS. 7(a), 7(b), and 7(c) show portions of heat exchanging modules according to other embodiments of the present invention. In each case what is shown and described are different configurations of a bottom plate, although it is appreciated that the various features of these figures can also be imposed on a top plate, as discussed earlier, or imposed on both the top and bottom plates.

FIG. 7(a) shows a bottom plate 146.2 in which can array of substantially parallel and linear projections 148 occupy a central portion of the internal flow path, thus creating a plurality of internal liquid flow channels 143. Bottom plate 146.2 includes a stagnation feature 148.7 at the liquid inlet 142.1. In some embodiments, liquid is provided to the modules with a non-uniform pressure distribution across the flow path. This non-uniform distribution can be corrected by flowing around feature 148.7, in conjunction with the plenum before and after the stagnation feature, to reduce the variation in the incoming flow, and thus provide more uniform flow among the downstream channels 143.

FIG. 7(b) shows a bottom plate 246.1 in which a plurality of short-length projections 248 arranged in groups are provided along the length of flow path 242. In some embodiments, these projections are substantially aligned along the length of the path, similar to the alignment previously discussed with regards to the external projections 50. However, in other embodiments projections within a group can be offset relative to their adjacent projections. Further, in other embodiments the projections within a group are substantially aligned with one another, but an upstream group can define a short channel that is offset from the upstream channel of the previous group, such that the flow streamlines along the length of flow path 242 are interrupted in between groups.

FIG. 7(c) shows a bottom plate 346.1 in which the interior of the module includes a plurality of diamond-shaped projections 348. A first projection downstream of a second projection can be substantially aligned with that second projection, or offset to create serpentine internal channels for liquid flow.

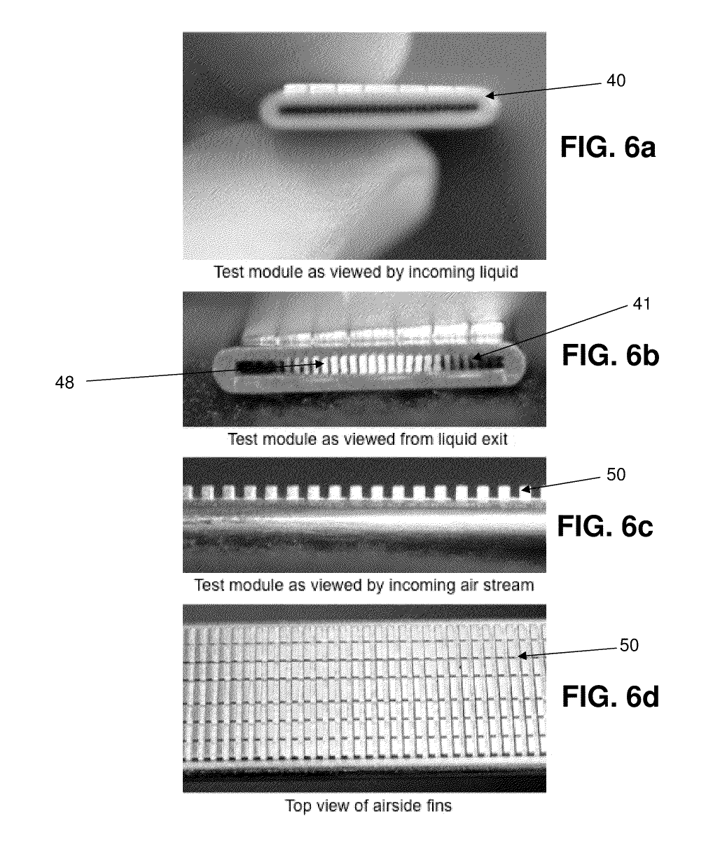

A module according to one embodiment of the present invention (as shown in FIG. 6) was analyzed and tested. The test facility incorporated an air loop and a water loop to simulate, respectively, the air and fuel flows that the heat exchanger would encounter in a supersonic turbine engine. In the air loop, compressed air flows through a series of filters to remove any impurities such as water, oil, solid particulates. The air passes through a venturi flow meter to measure the air flow rate. Two different sonic venturis are used to provide broad coverage of flow rates. The air stream is heated by an inline heater to simulate air heating in a turbine engine, albeit at lower temperatures. A solid-state controller with an accuracy of ±2° C. is used to regulate the air temperature to the desired level between room temperature and 260° C. Exiting the heater, the air enters a flow straightener to provide uniform flow at the inlet to the heat exchanger test module. The heated air converges through a nozzle before entering the test section containing the test module.

The water flow loop provides water flow that is regulated to the desired flow rate and temperature as it enters the test module. The pump, reservoir, and water to air heat exchanger are all parts of an integral unit acquired from Lytron Inc. The filtered water is passed through one of three flow meters before entering the test module. The heat exchanger test module was contained in a PEEK plastic housing that provides thermal insulation for both the air and the water flows.

Shown in FIGS. 3a and 3b, a module according to one embodiment of the present invention was fabricated from stainless steel and measures 76.2 mm long and 15.24 mm wide. The airside fins cover one side of the test module excepting two 5.08 mm end regions of the same surface to allow a secure press fit into the insulating PEEK housing. Since the two end regions do not contribute to the heat transfer between the air and the water, the module simulates a 66.04 mm heat exchanger module in a turbine engine.

As illustrated in FIGS. 3 and 5a, the module's airside of 65 rows of fins. Each fin row includes of seven fins, six of which measure 1.524 mm while the middle fin measures 2.032 mm. The airside fin rows are angled to allow for a tighter packaging arrangement in an annular turbine heat exchanger design (see FIG. 4b). Fin height varies from 0.635 mm at the high edge to 0.127 mm at the lower, forming a 2.29° angle with the surface of the test module. As shown in FIG. 5a, the waterside includes 26 of 0.254 mm wide by 0.762 mm high micro-channels running the middle 66.04 mm of the test module's length.

A module used in a gas turbine engine heat exchanger could be made of a nickel alloy to withstand the engine's high temperatures, the test module was made of stainless steel because of its somewhat similar thermal conductivity and relative ease of machining compared to nickel alloys. The test module was fabricated from two flat stainless steel plates. One was used to form a cover plate and the second the main body of the test module. The micro-channels were formed by holding the outer ends of the main plate in an aluminum fixture and cutting 0.762 mm deep parallel grooves using a series of miniature saw blades attached to an arbor, separated by thin spacers. The blade thickness equaled the width of the micro-channels, and the spacer thickness the width of solid wall between micro-channels, both 0.254 mm. A similar technique was used to form the airside fins. Those of ordinary skill in the art will recognize that the fabrication method for the test module is by way of example only, and various embodiments of the present invention contemplate any type of fabrication.

The cover plate was soldered onto the base plate. The sides of the assembled module were rounded off to allow for more streamlined airflow around the module. Solder was applied to the base plate before the micro-channels were cut, leaving the appropriate amount of solder on top of the fins. This prevented excess solder from running off and filling the micro-channels after machining. FIG. 6 show photos of the completed test module. Those of ordinary skill in the art will recognize that the assembly method used for the test module is by way of example only, and other embodiments of the present invention contemplate any type of joining method, including brazing, welding, and diffusion bonding.

The approach used to model the thermal performance of the air-fuel heat exchanger includes first determining the temperature distributions for both the air and fuel streams across a single module. The method used here uses a mean overall heat transfer coefficient, U, between the air and the fluid streams that is assumed constant across the module. This coefficient is a function of the convective heat transfer coefficients for the air and the fluid, as well as the conduction resistances associated with the micro-channel plate and the air fins. Averaging the effects of the tapered air flow on the finned side of the test module will be discussed.

The module's total heat transfer rate must also equal the sensible heat lost by the hot stream or gained by the cold stream

$$\begin{matrix}q = UWL [ {T}_{h} ( 0 , 0 ) - {T}_{c} ( 0 , 0 ) ] φ & ( 1 ) \\ q = {\dot{m}}_{h} {c}_{p , h} [ {T}_{h} ( 0 , 0 ) - {\overline{T}}_{h , o} ] = {\dot{m}}_{c} {c}_{p , c} [ {\overline{T}}_{c , o} - {T}_{c} ( 0 , 0 ) ] & ( 2 ) \\ a = \frac{UWL}{{\dot{m}}_{h} {c}_{p , h}} & ( 3 ) \\ b = \frac{UWL}{{\dot{m}}_{c} {c}_{p , c}} & ( 4 )\end{matrix}$$

where T̅_{h,o} and T̅_{c,o} are the mean outlet temperatures of the hot stream and the cold stream, respectively. Combining Eqs. (1) and (2) and introducing the definitions of a and b from Eqs. (3) and (4), respectively, yield the following relations for the mean outlet temperatures.

T̅_{h,o}=Tₕ(0,0)−a[Tₕ(0,0)−T_{c}(0,0)]φ (5)

and

T̅_{c,o}=T_{c}(0,0)−b[Tₕ(0,0)−T_{c}(0,0)]φ (6)

The performance parameters of the heat exchanger module includes total heat transfer rate, q, which can be determined from Eq. (1), outlet temperature of the hot stream, T̅_{h,o}, from Eq. (5), and outlet temperature of the cold stream, T̅_{c,o}, from Eq. (6). Calculating these three parameters includes determining a and b from Eqs. (3) and (4), respectively, and φ from Eq. 7.

$$φ = \frac{1}{ab} {\sum }_{N = 0}^{∞} [ 1 - {e}^{- a} {\sum }_{k = 0}^{n} \frac{{a}^{k}}{k !} ] [ 1 - {e}^{- b} {\sum }_{k = 0}^{n} \frac{{b}^{k}}{k !} ] \qquad ( 7 )$$

The only unknown in the parameter a in Eq. (1) and b in Eq. (2) is the overall heat transfer coefficient, U. This parameter can be determined by using a thermal resistance network using the heat exchanger module geometry illustrated in FIG. 6(a). On one surface of the module, the air flows over the external fins as well as along the surface between the fins. The air also flows over the back surface of the module. The fluid travels through the micro-channels. Details of the airside and fluid-side boundaries are given in FIGS. 6(b) and 6(c). The number of airside fin rows, N_{h,f}, and fuel-side micro-channels, N_{c,ch} can be found using the following relations

$$\begin{matrix}{N}_{h , f} = \frac{L}{{W}_{h , ch} + {W}_{h , f}} and & ( 8 ) \\ {N}_{c , ch} = \frac{L}{{W}_{c , ch} + {W}_{c , w}} , & ( 9 )\end{matrix}$$

respectively.

The airside resistance is:

$${R}_{h , 1} = \frac{1}{{N}_{h , f} [ {η}_{h , f} {\overline{h}}_{h , f} {A}_{h , f} + {\overline{h}}_{h , uf} {A}_{h , uf}} \qquad ( 10 )$$

The thermal resistance of the outer wall is:

$${R}_{cond} = \frac{{H}_{c , w}}{{k}_{s} ( LW} \qquad ( 11 )$$

There are two expressions for fluid sidewall resistances,

$$\begin{matrix}{R}_{c , swl} = \frac{1}{{N}_{c , ch} \sqrt{{\overline{h}}_{c} {P}_{c , f} {k}_{s} {A}_{c , csf}} coth ( \sqrt{\frac{{\overline{h}}_{c} {P}_{c , f}}{{k}_{s} {A}_{c , csf}} {H}_{c , ch}} )} and & ( 12 ) \\ {R}_{c , sw 2} = \frac{1}{{N}_{c , ch} \sqrt{{\overline{h}}_{c} {P}_{c , f} {k}_{s} {A}_{c , csf}} csch ( \sqrt{\frac{{\overline{h}}_{c} {P}_{c , f}}{{k}_{s} {A}_{c , csf}} {H}_{c , ch}} )} & ( 13 )\end{matrix}$$

The expression for base convective resistance is:

$${R}_{c , 2} = \frac{1}{{N}_{c , ch} {\overline{h}}_{c} ( {W}_{c , ch} L )} \qquad ( 14 )$$

Thee is direct convection for surface 3 of the micro-channel to the fluid, which is associated with a similar convective resistance.

$${R}_{c , 3} = \frac{1}{{N}_{c , ch} {\overline{h}}_{c} ( {W}_{c , ch} L )} \qquad ( 15 )$$

The following is an expression for convective resistance:

$${R}_{h , 4} = \frac{1}{{\overline{h}}_{h , b} ( WL )} \qquad ( 16 )$$

As shown in FIG. 7, the total resistance may be represented as the equivalent of two parallel branches A and B. Each branch includes a series of three resistances; the third of which is the equivalent of two parallel resistances. Therefore,

$$\begin{matrix}{R}_{tot} = \frac{{R}_{A} {R}_{B}}{{R}_{A} + {R}_{B}} , where & ( 17 ) \\ {R}_{A} = {R}_{h , 1} + {R}_{cond} + \frac{{R}_{c , sw 1} {R}_{c , 2}}{{R}_{c , sw 1} + {R}_{c , 2}} and & ( 18 ) \\ {R}_{B} = {R}_{h , 4} + {R}_{cond} + \frac{{R}_{c , cw 2} {R}_{c , 3}}{{R}_{c , cw 2} + {R}_{c , 3}} & ( 19 )\end{matrix}$$

In the airside fin calculations, laminar flow over a flat plate is assumed, based on the low Reynolds numbers associated with the present application and the experimental validation study. For this assumption to be valid for the air passage between two adjacent rows of fins, the boundary layer thickness should be smaller than the spacing between fin rows. The airside fin efficiency can be determined by using the approximation for a fin with an adiabatic tip because h̅_{h,f}W_{h,f}/kₛ≦0.0625 for the present study. Laminar flow over a flat plate is also assumed for the airside base calculations between fins.

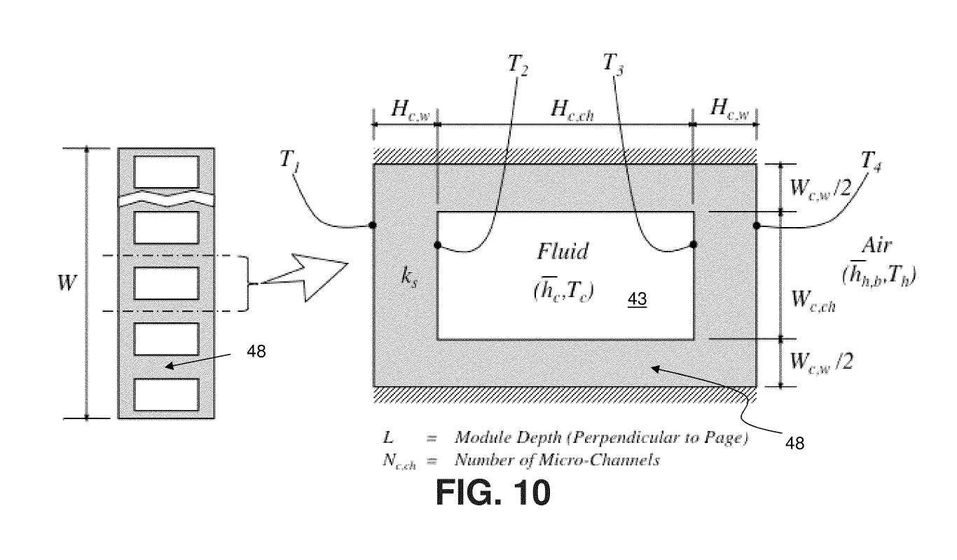

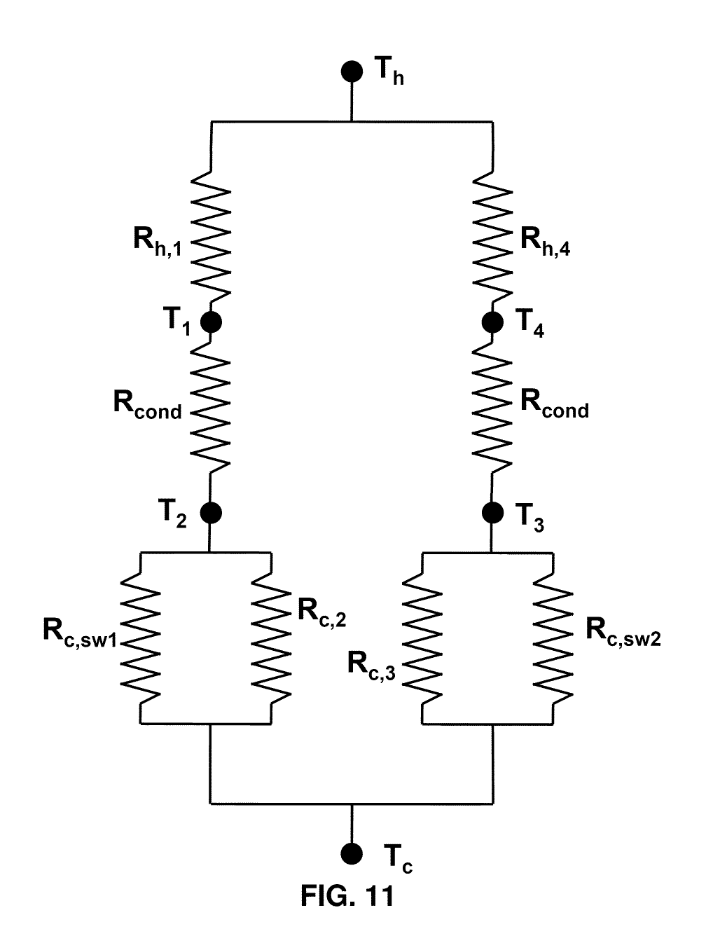

Unlike the finned side, the air flow along the back of the module (see FIG. 10) is internal, given the small back flow clearance s₂. Here, a correlation for laminar flow in a channel with an equivalent hydraulic diameter is used. The fuel-side convection coefficient is determined from correlations for flow in a circular channel that are corrected for equivalent hydraulic diameter of the micro-channel. For laminar flow conditions of interest, two different correlations are recommended based on Prandtl number range.

Table 1 provides correlations or relations for the airside and fluid-side heat transfer coefficients and fins that are used to evaluate the overall heat transfer coefficient U. It should be noted that a viscosity ratio term that appears in the heat transfer coefficient correlations in Table 1 was set equal to unity in the present study.

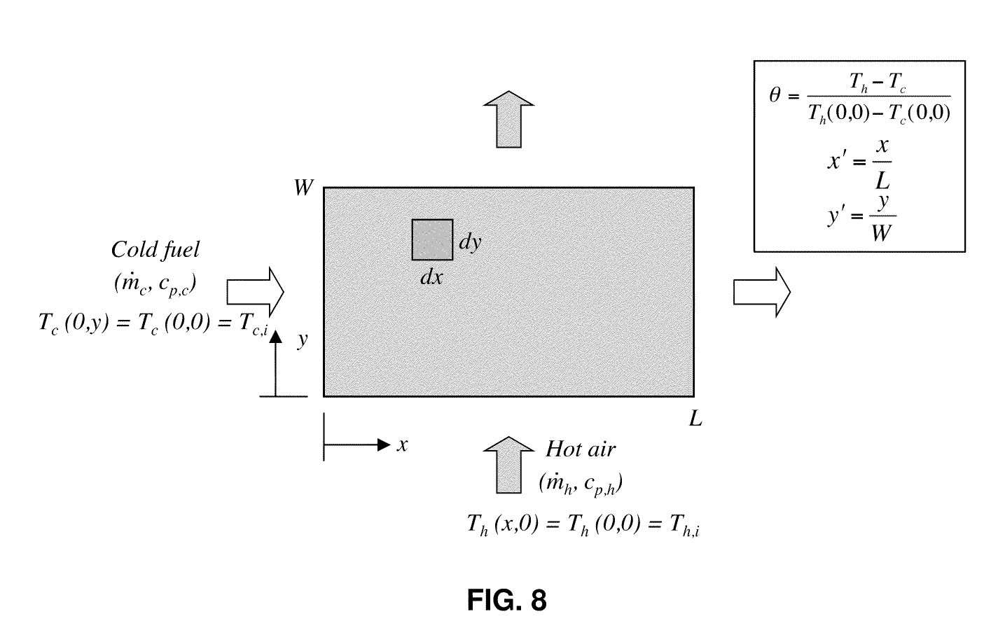

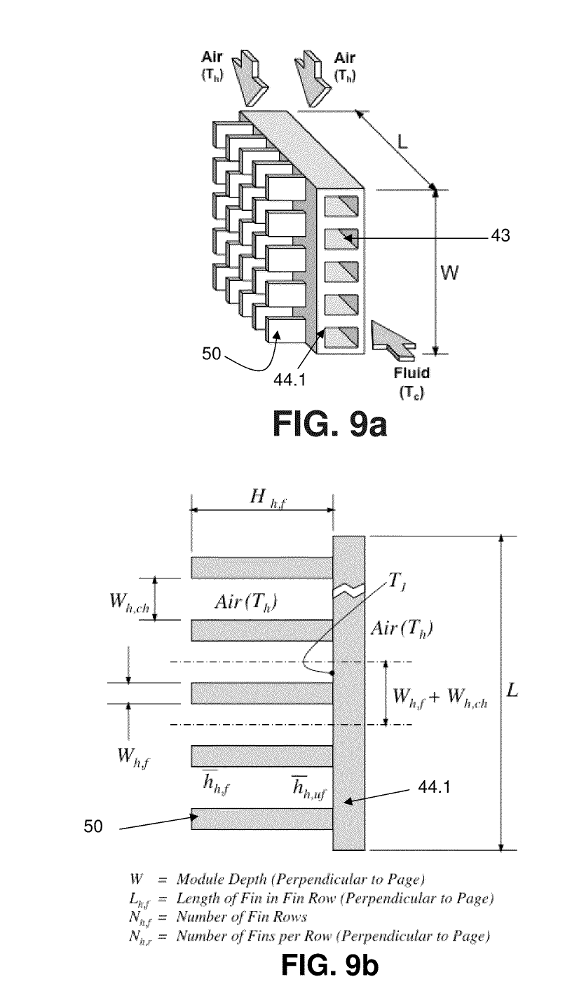

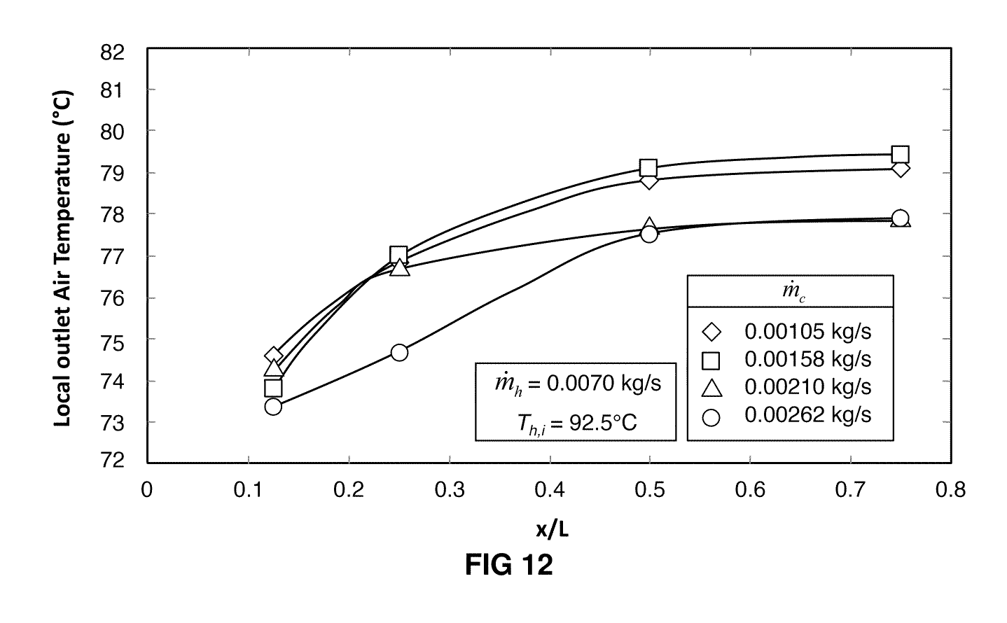

FIG. 12 shows the measured outlet airside temperature profile for a fixed inlet air temperature and fixed flow rate and four water flow rates. Notice that the air temperature is lowest at x=0 (see FIG. 8), where the water is coolest, and highest at x=L, where the water is warmest. Also, notice the gradient of the airside temperature profile is strongest near x=0, especially near y=0, where local heat transfer rate between the air and the water is greatest.

Since the airside fins in some embodiments are tapered, with the tallest fin at the air inlet and becoming progressively shorter, the values that are functions of air fin height—such as air velocity and air fin efficiency—vary across the module. To arrive at an average value for the overall heat transfer coefficient, U, for the test module and compare the model predictions to the test module results, an average fin height is used. Since the height of the air fins changes linearly, the average fin height is the height of the fin in the middle of the module. Therefore, the terms calculated from the average fin height are essentially values for the middle of the module.

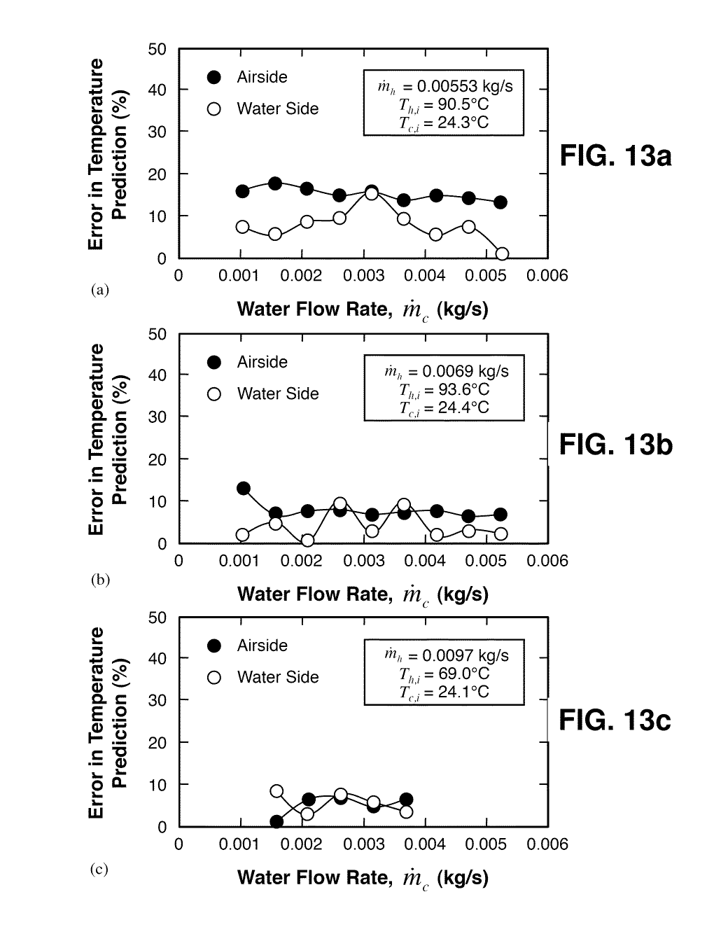

FIG. 13 show the percent error in predicting the temperature drop across the air and water streams for three sets of operating conditions. For the airside, the percent temperature error is defined as

$$\% Airside temperature error = \frac{\vert {T}_{h , o , exp} - {T}_{h , o , th} \vert}{( {T}_{h , in , exp} - {T}_{h , o , exp} )} \qquad ( 20 )$$

where T_{h,in,exp}, T_{h,o,exp}, and T_{h,o,th} are the measured inlet temperature, the measured mean outlet temperature, and the predicted mean outlet temperature, respectively. Similarly, the percent temperature error for the waterside is defined as

$$\% Waterside temperature error = \frac{\vert {T}_{c , o , exp} - {T}_{c , o , th} \vert}{( {T}_{c , o , exp} - {T}_{c , in , exp} )} \qquad ( 21 )$$

where T_{con,exp}, T_{c,o,exp}, and T_{c,o,th} are the measured inlet temperature, the measured mean outlet temperature, and the predicted mean outlet temperature, respectively. FIG. 13 show errors for both the air- and watersides are mostly below 10% for the two higher airside flow rates but increase to about 15% for the lowest airside flow rate, where venturi measurement error is greatest. There are uncertainties associated with the various instruments used such as the venturis and the water flow meters. Also, there were slight fluctuations in the water flow rate, which created added difficulty in pinpointing the exact water flow rate and caused slight fluctuations in the air outlet temperature. Third, the model calculations are based on an average fin height for the finned airside of the test module, which introduces some error in predicting the module performance. Nonetheless, the small error values in FIG. 13 support the overall accuracy of the heat exchanger model.

The module's heat transfer rates are measured and calculated for the cold and hot streams, respectively, as

q_{c}=\dot{m}_{c}c_{p,c}( T̅_{c,o}−T_{c}) (22)

and

qₕ=\dot{m}ₕc_{p,h}( T̅_{h,o}−T_{h,o}) (23)

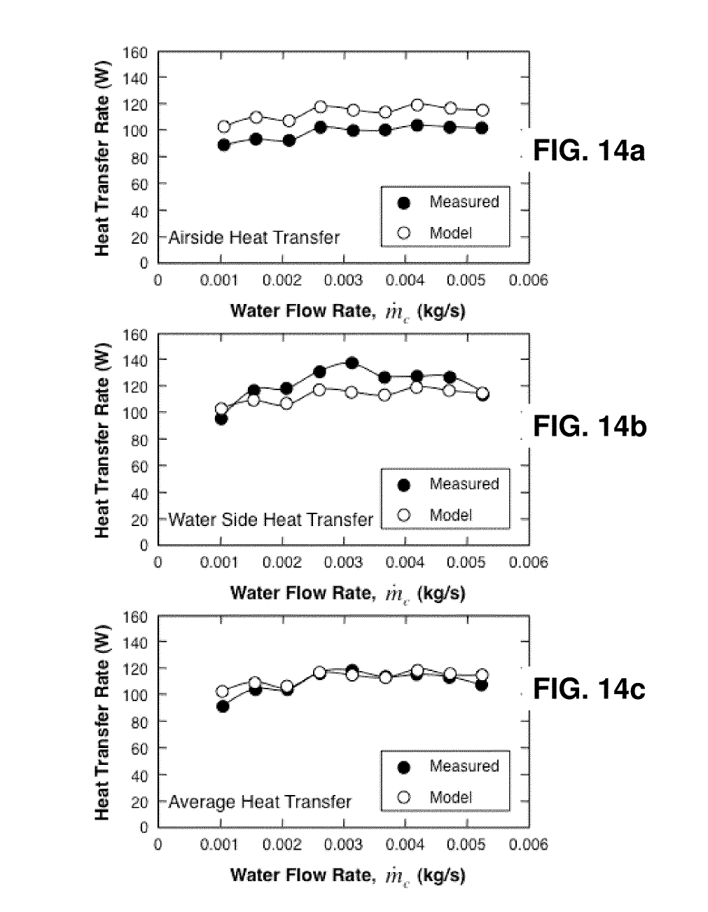

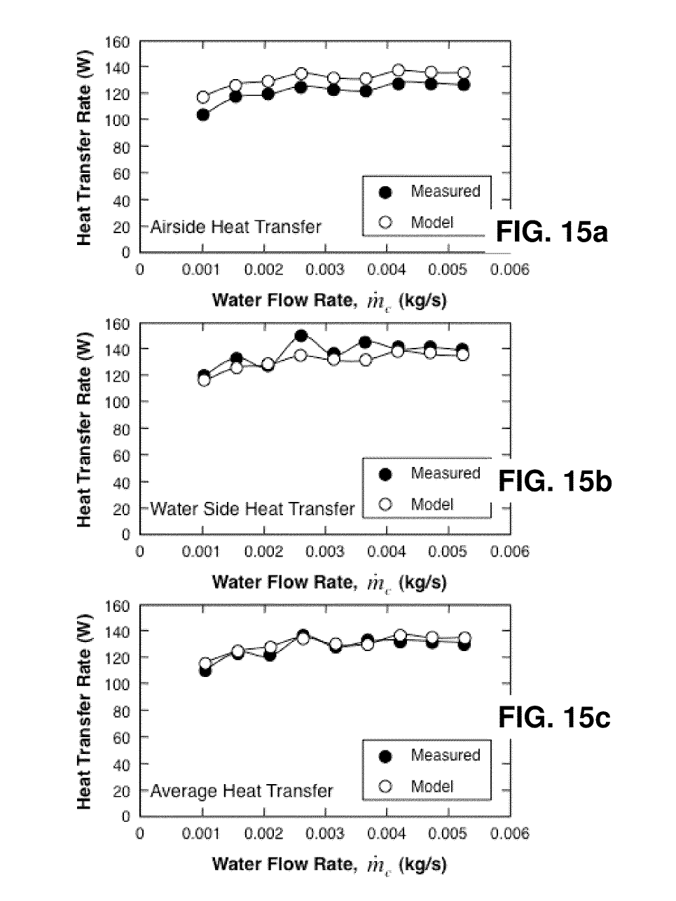

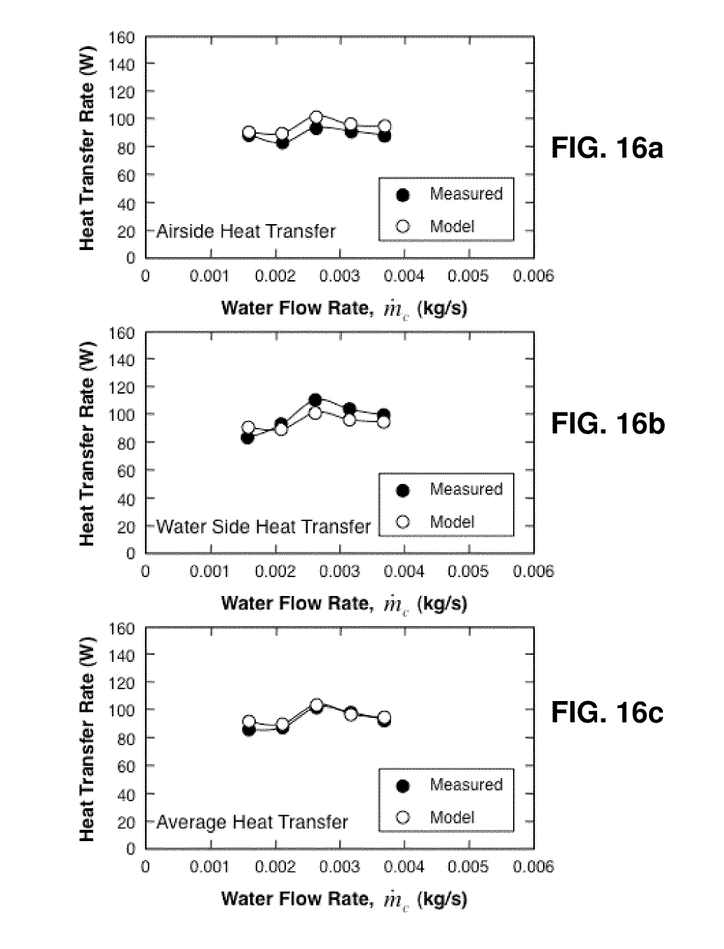

FIGS. 14, 15 and 6 compare predicted and measured heat transfer rates for the waterside and airside calculated according to Eqs. (22) and (23), respectively. These results show good agreement in both magnitude and trend. There is an increase in overall heat transfer rate between FIGS. 14 and 15 mostly because of the increasing air flow rate. An appreciable decrease in the heat transfer rate between FIGS. 15 and 16 appears to be mostly the result of the large decrease in air inlet temperature despite the higher air flow rate.

To further assess the accuracy of the model predictions of the module's heat transfer rate, the following error parameter is defined,

$$\% Heat transfer rate error = \frac{\vert ( \frac{{q}_{h , exp} + {q}_{c , exp )}}{2} ) - ( \frac{{q}_{h , th} + {q}_{c , th}}{2} ) \vert}{( \frac{{q}_{h , exp} + {q}_{c , exp}}{2} )} \qquad ( 24 )$$

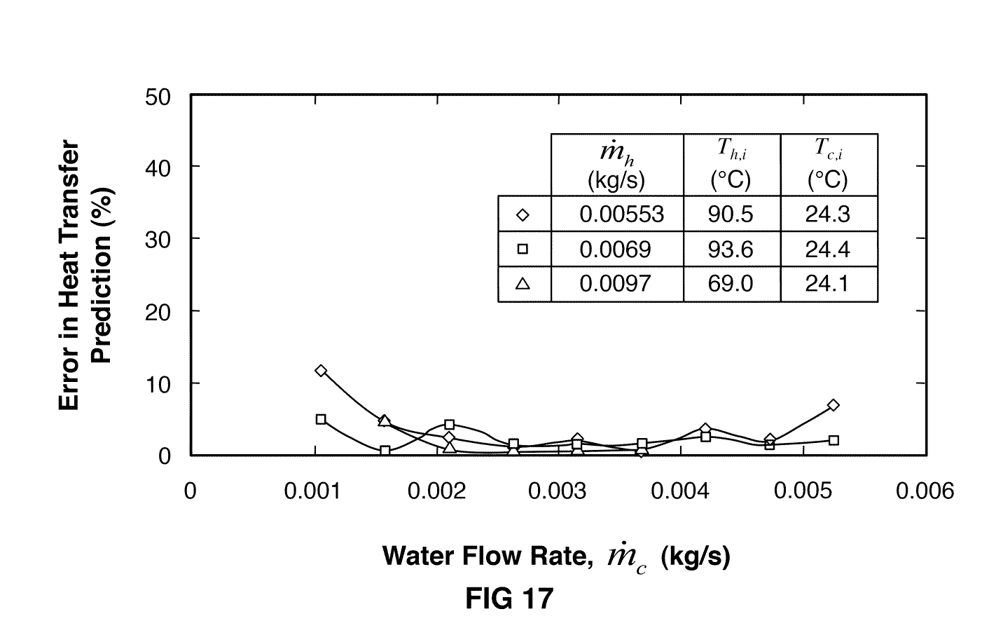

FIG. 17 shows good agreement between model and experiment, with values for all except one test falling below 10% error.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for exchanging heat between a gas and a liquid, comprising:
providing a plurality of heat exchanging modules each including an internal liquid flowpath, each module having external fins for exchanging heat with the gas;
arranging the plurality in a pattern that is radial about an axis;
flowing the gas radially inward through the pattern and over the fins;
flowing the liquid within the plurality of modules in a direction parallel to the axis; and
exchanging heat between the liquid and the gas by said flowing the gas and said flowing the liquid.

2. The method of claim 1 which further comprises turning the gas to a substantially axial direction after said flowing the gas;

3. The method of claim 2 wherein said providing includes a gas-cooled component of a gas turbine engine, and which further comprises directing the axially flowing gas to the component.

4. The method of claim 1 wherein the liquid is fuel and the gas is compressed air from a gas turbine.

5. The method of claim 1 which further comprises directing the liquid flowing out of the plurality to a combustor for combustion.

6. The method of claim 1 wherein each liquid flowpath has substantially the same shape as the shape of the internal flowpath of a flattened tube.

7. The method of claim 6 which further comprises structurally connecting the flattened walls by a plurality of internal fins.

8. The method of claim 1 which further comprises arranging the plurality of liquid flowpaths in parallel to one another.

9. The method of claim 1 wherein the radial pattern is a complete circle.

10. An apparatus for exchanging heat between a gas and a liquid, comprising:
a gas inlet duct and a gas outlet duct;
a liquid inlet manifold and a liquid outlet manifold; and
a plurality of substantially identical heat exchanging modules, each module having a liquid inlet and liquid outlet and a closed-wall interior flowpath therebetween, each interior including a first plurality of spaced-apart projections adapted and configured for exchanging heat between the liquid and a wall, each module having an exterior including a second plurality of spaced-apart projections adapted and configured for exchanging heat between the gas and a wall;
wherein said plurality of modules are arranged in a group such the flowpaths of adjacent modules are aligned for parallel flow in a first direction, each said liquid inlet being in fluid communication with said inlet manifold, each said liquid outlet being in fluid communication with said outlet manifold, and said inlet duct and said outlet duct are adapted and configured to flow gas over the exterior of said plurality modules in a second direction not parallel to the first direction.

11. The apparatus of claim 10 wherein the group is arranged about an axis, and the first direction is parallel to the axis, and the second direction is radial about the axis.

12. The apparatus of claim 11 wherein the second direction is radially inward.

13. The apparatus of claim 10 wherein the liquid is a hydrocarbon fuel.

14. The apparatus of claim 13 wherein the gas is compressed air from a gas turbine engine.

15. The apparatus of claim 10 wherein the interior flowpath is substantially straight.

16. The apparatus of claim 10 wherein the interior flowpath has a hydraulic diameter less than about one millimeter.

17. An apparatus for exchanging heat between a gas and a liquid, comprising:
a heat exchanging module having a liquid inlet and liquid outlet and defining an interior with a liquid flowpath, said module having a pair of opposing top and bottom walls and a first plurality of spaced-apart projections within the interior, each of said first projections being structurally coupled to both said top and bottom walls and each being adapted and configured for exchanging heat between the liquid and said top wall, each module having an exterior including a second plurality of spaced-apart external projections adapted and configured for exchanging heat between the gas and the exterior of said top wall, each projection of said second plurality of projections being substantially parallel to each adjacent projection;
wherein the liquid flowpath is adapted and configured to flow liquid in a first direction, said second projections are aligned to flow gas in a second direction, and the second direction is substantially orthogonal to the first direction.

18. The apparatus of claim 17 wherein each pair of adjacent first projections define a liquid flowpath therebetween having a hydraulic diameter less than about one millimeter.

19. The apparatus of claim 17 wherein said first projections are elongated in the direction of liquid flow forming a plurality of parallel channels within the flowpath.

20. The apparatus of claim 19 wherein the liquid inlet includes a stagnation feature adapted and configured to redistribute liquid received in the inlet before the liquid flows within the channels.

21. The apparatus of claim 17 wherein said first projections are diamond-shaped.

22. The apparatus of claim 17 wherein the liquid inlet includes a stagnation feature adapted and configured to redistribute liquid received in the inlet before the liquid flows around the first projections.

23. The apparatus of claim 17 wherein each of said second projections has a length in the second direction and includes a disturbance feature along the length adapted and configured to reinitiate the boundary layer of the flowing gas.

24. The apparatus of claim 23 wherein the disturbance feature is an interruption in each second projection intermediate of the ends of the respective second projection.

25. The apparatus of claim 17 wherein each of said second projections a length in the second direction and a variable height from said top wall, and the height of each second projection monotonically increases in the direction.

26. The apparatus of claim 25 wherein the height increases constantly in the direction.

27. The apparatus of claim 17 wherein said module includes a pair of opposing end walls, said ends walls and said top and bottom walls defining a pressure vessel.

28. The apparatus of claim 27 wherein said module includes first and second plates, said first plate including said top wall, said first projections and said second projections, and said second plate including said bottom wall.

29. The apparatus of claim 28 wherein said end walls are integral with said first plate.

30. The apparatus of claim 28 wherein said end walls are integral with said second plate.

31. The apparatus of claim 28 wherein said first projections of said first plate are joined to said second plate by one of welding, brazing, or diffusion bonding.

32. The apparatus of claim 17 which further comprises means for restarting the boundary layer of said external projections.
